(19) United States
(12) Patent Application Publication
(10) Pub. No.: US 2011/0080747 A1
(43) Pub. Date: Apr. 7, 2011

(54) LED LIGHT STRUCTURE

(76) Inventor: SU-HSIN YEH, Taoyuan (TW)

(21) Appl. No.: 12/575,066

(22) Filed: Oct. 7, 2009

(51) Int. Cl. F21V 19/00

(52) U.S. Cl. 362/382; 257/99

(57) ABSTRACT

A LED light structure is designed to replace a LED unit easily by user as the LED unit is broken, and a plate member disposed in the LED light structure is removed quickly as replacement. In addition, a heat generating from the LED light structure is eliminated effectively so as to prolong service life of the LED light structure.

### BACKGROUND OF THE INVENTION

1. Field of the Invention

The present invention relates to a LED light structure, and more particularly to a LED light disposed on a light housing.

2. Description of the Prior Art

As shown in FIG. 6, a conventional plate member 90 of a LED light is designed in a thin plate shape and includes a LED unit 91 and a number of apertures 92 arranged around the plate member 90 so as to be fixed to a light housing (the fixing elements and the light housing not shown) by using fixing elements, and then to be connected with a wire to emit light.

However, as an emitting element in the LED unit 91 is broken that has to be replaced, a user has to remove and replace the LED unit by using a tool, having a tedious disassembly and assembly.

The present invention has arisen to mitigate and/or obviate the afore-described disadvantages.

### SUMMARY OF THE INVENTION

The primary object of the present invention is to provide a LED light structure that when replacing the LED unit, the plate member is removed easily.

Another object of the present invention is to provide a LED light structure that waste heat generating from the plate member is eliminated quickly.

A LED light structure in accordance with a preferred embodiment of the present invention comprises:

a base including a hollow chamber having a plurality of engaging blocks disposed around the hollow chamber and spaced apart from each other, each engaging block including an aperture secured thereon, and the base including two raised locking tabs mounted on two sides thereof and a positioning member fixed on a rear end thereof and having a groove defined between the positioning member and the base, the groove including a fixing pillar received therein, the base further including a retaining piece arranged on a front end thereof and having a slot and a pressing projection, the slot being disposed on an inner side wall of the retaining piece;

a heat conducting assembly including a heat conducting panel having a number of bores arranged on the heat conducting panel to correspond to the apertures of the base, and including a hot glue member mounted on a top surface of the heat conducting panel, the heat conducting assembly and the heat conducting panel being assembled together by using two fixing elements, and the heat conducting panel including an extension extending from a bottom surface thereof to be inserted to the hollow chamber of the base;

a plate member being a thin plate and includes a LED unit, and being adhered to the heat conducting panel and the hot glue member so as to be further positioned between the locking tabs of the base, the positioning member, and the retaining piece, the plate member also including a recess formed on one side thereof to be retained to the fixing pillar and another side thereof is engaged to the slot of the retaining piece.

### BRIEF DESCRIPTION OF THE DRAWINGS

FIG. 1 is a perspective view showing the assembly of a LED light structure according to a preferred embodiment of the present invention;

FIG. 2 is a perspective view showing the exploded components of the LED light structure according to the preferred embodiment of the present invention;

FIG. 3 is a perspective view showing the assembly of a plate member of the LED light structure according to the preferred embodiment of the present invention;

FIG. 4 is a perspective view showing the assembly of a base of the LED light structure according to the preferred embodiment of the present invention;

FIG. 5 is a partial amplified view of FIG. 1;

FIG. 6 is a perspective view of a conventional LED light structure.

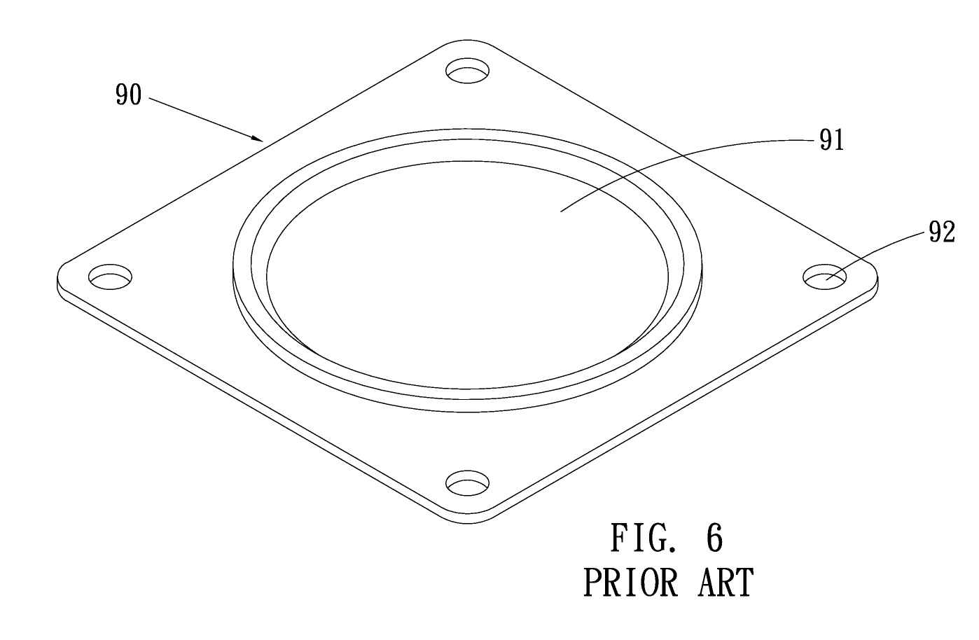

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

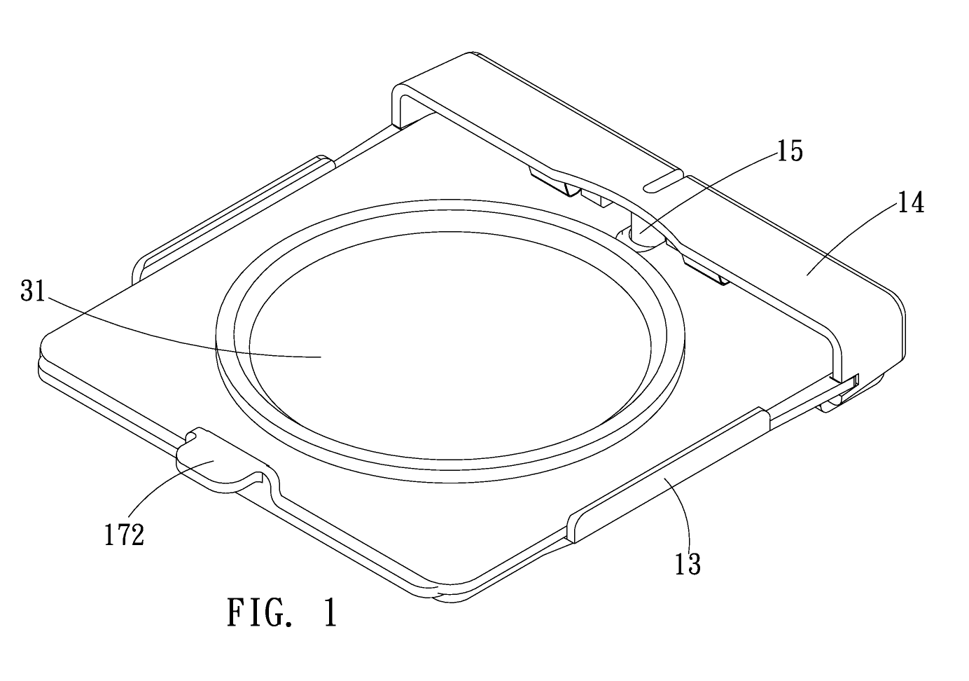

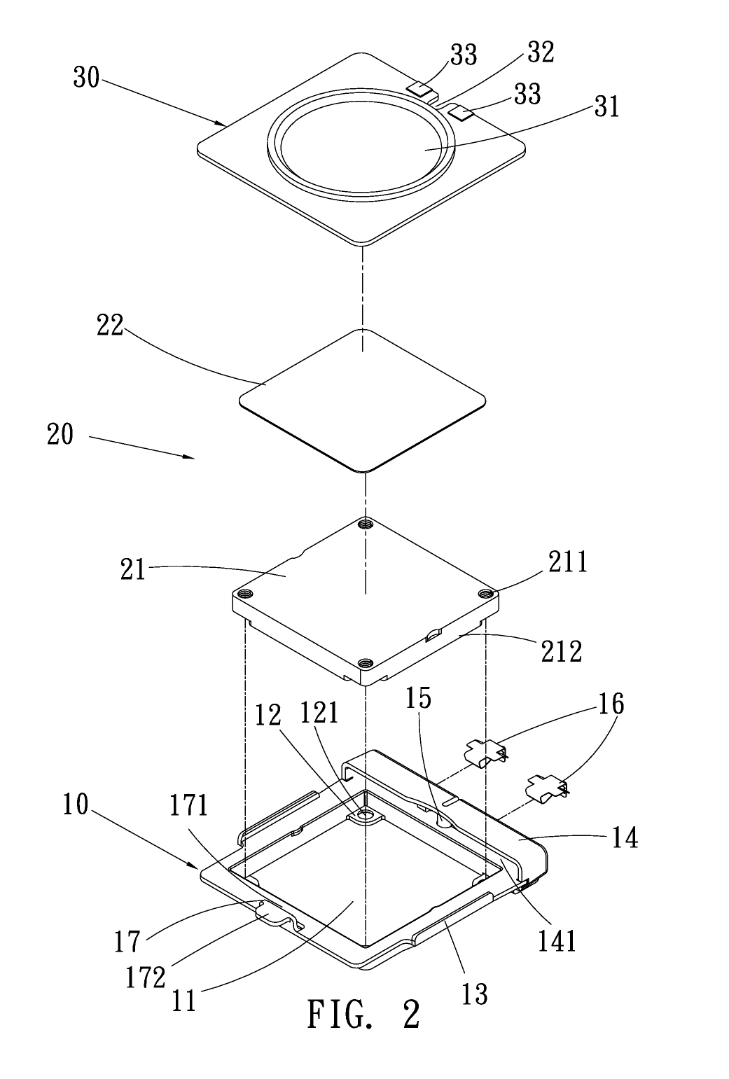

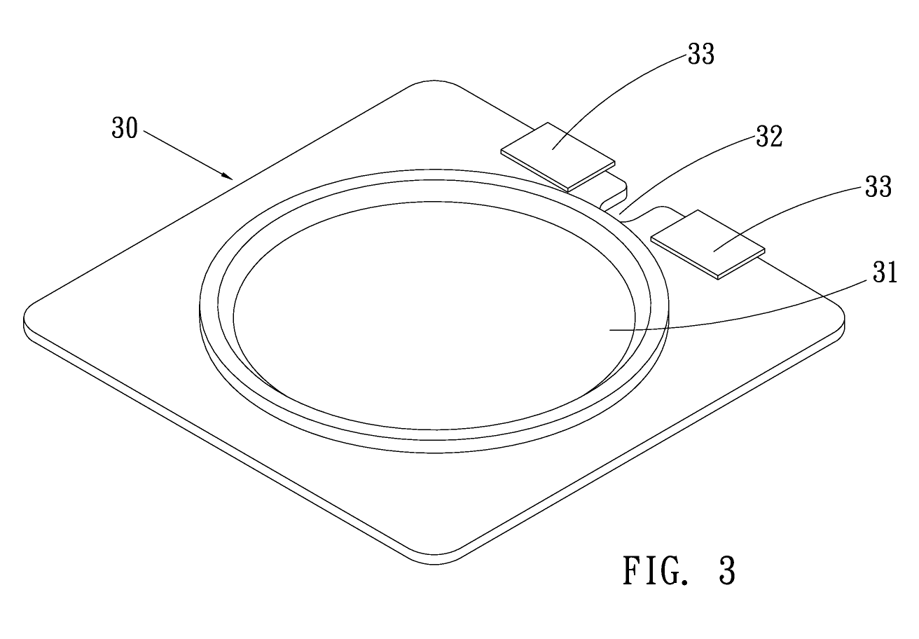

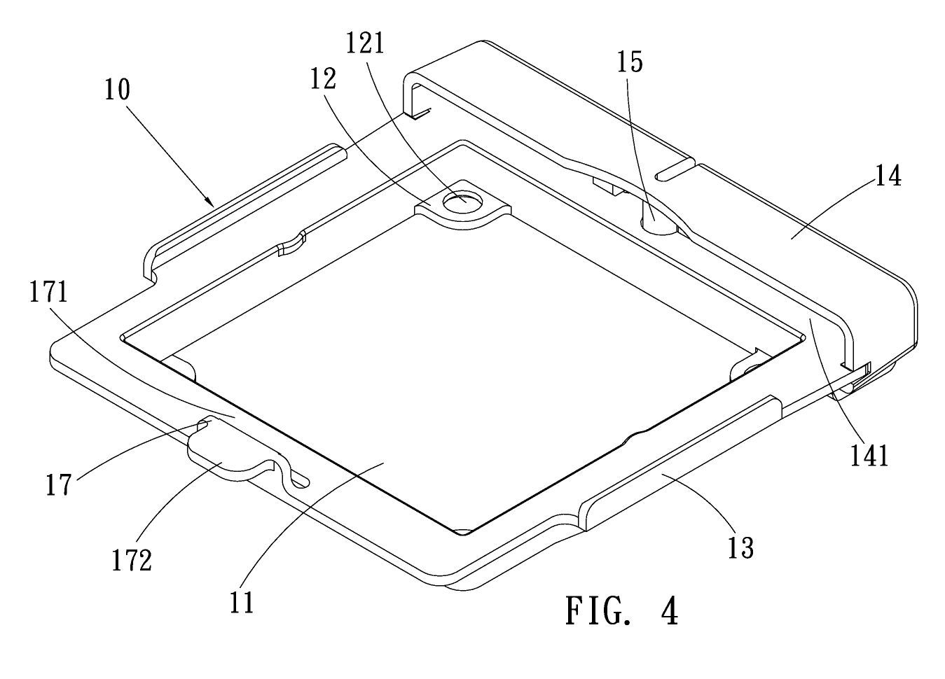

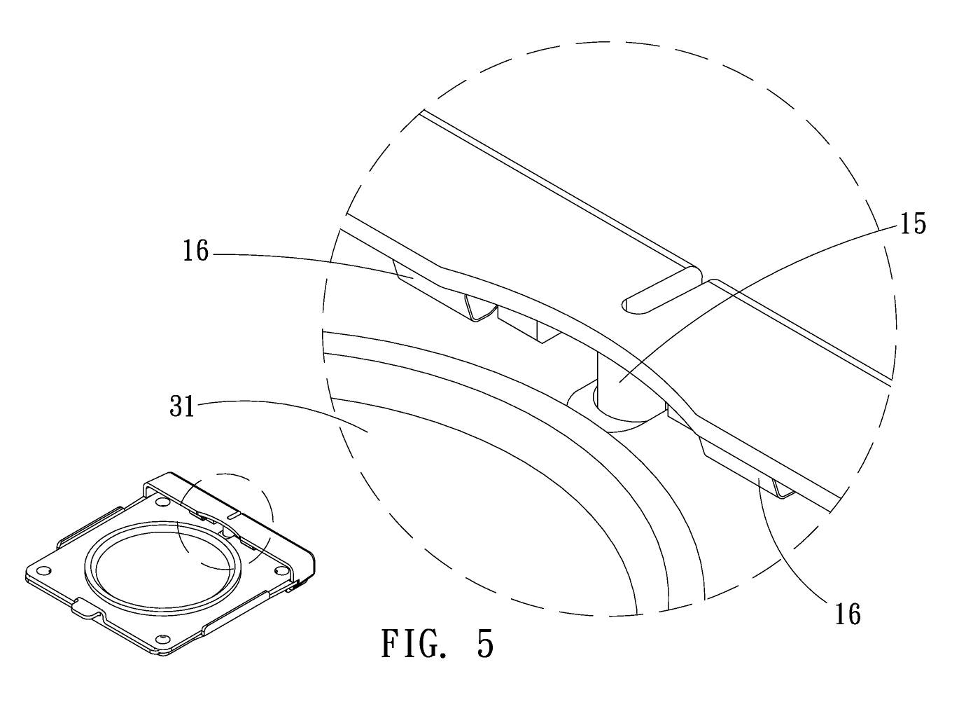

Referring to FIGS. 1-5, a LED light structure in accordance with a preferred embodiment of the present invention is assembled to a light housing (not shown) with a plurality of screw holes and includes a base 10, a heat conducting assembly 20, and a plate member 30; wherein the base 10 includes a hollow chamber 11 in a square shape and having a plurality of engaging blocks 12 disposed around the hollow chamber 11 and spaced apart from each other, each engaging block 12 includes an aperture 121 secured thereon so as to correspond to the screw hole of the light housing, and the base 10 includes two raised locking tabs 13 mounted on two sides thereof and includes a positioning member 14 fixed on a rear end thereof and having a groove 141 defined between the positioning member 14 and the base 10, the groove 141 includes a fixing pillar 15 and two conduction members 16 received therein, wherein each conduction member 16 is connected to a wire so as to supply a power source, and the base 10 further includes a retaining piece 17 arranged on a front end thereof and having a slot 171 and a pressing projection 172, the slot 171 is disposed on an inner side wall of the retaining piece 17, and the pressing projection 172 is mounted on a top end of the retaining piece 17 and extends outward so as to be pressed by a user to actuate the retaining piece 17 to turn outward.

The heat conducting assembly 20 includes a heat conducting panel 21 having a number of bores 211 arranged on the heat conducting panel 21 to correspond to the apertures 121 of the base 10, and includes a hot glue member 22 made of a heat conducting material. The heat conducting assembly 20 and the heat conducting panel 21 are assembled together by using two fixing elements, and the heat conducting panel 21 includes an extension 212 extending from a bottom surface thereof to be inserted to the hollow chamber 11 of the base 10 so as to connect with the light housing, thus releasing heat, and the hot glue member 22 is attached to a top surface of the heat conducting panel 21.

The plate member 30 is a thin plate and includes a LED unit 31, and is adhered to the heat conducting panel 21 and the hot glue member 22 so as to be further positioned between the locking tabs 13 of the base 10, the positioning member 14, and the retaining piece 17. The plate member 30 also includes a recess 32 formed on one side thereof to be retained to the fixing pillar 15 and another side thereof is engaged to the slot 171 of the retaining piece 17, the plate member 30 further includes an electrically connecting end 33 disposed on two sides of the recess 32 so as to contact with the conduction member 16 of the base 10, hence the power source is transmitted to the LED unit 31 to emit light.

Thereby, when the LED unit 31 is broken that has to be replaced, the plate member 30 is removed easily by pressing the retaining tabs 17. Likewise, because the plate member 30 contacts with the heat conducting assembly 20 directly, waste heat generating from the plate member 30 is eliminated quickly. While we have shown and described various embodiments in accordance with the present invention, it is clear to those skilled in the art that further embodiments may be made without departing from the scope of the present invention.

What is claimed is:

1. A LED light structure comprising:
a base including a hollow chamber having a plurality of engaging blocks disposed around the hollow chamber and spaced apart from each other, each engaging block including an aperture secured thereon, and the base including two raised locking tabs mounted on two sides thereof and a positioning member fixed on a rear end thereof and having a groove defined between the positioning member and the base, the groove including a fixing pillar received therein, the base further including a retaining piece arranged on a front end thereof and having a slot and a pressing projection, the slot being disposed on an inner side wall of the retaining piece;
a heat conducting assembly including a heat conducting panel having a number of bores arranged on the heat conducting panel to correspond to the apertures of the base, and including a hot glue member mounted on a top surface of the heat conducting panel, the heat conducting assembly and the heat conducting panel being assembled together by using two fixing elements, and the heat conducting panel including an extension extending from a bottom surface thereof to be inserted to the hollow chamber of the base;
a plate member being a thin plate and includes a LED unit, and being adhered to the heat conducting panel and the hot glue member so as to be further positioned between the locking tabs of the base, the positioning member, and the retaining piece, the plate member also including a recess formed on one side thereof to be retained to the fixing pillar and another side thereof is engaged to the slot of the retaining piece.

2. The LED light structure as claimed in claim 1, wherein the groove further includes two conduction members received therein, and each conduction member is connected to a wire.

3. The LED light structure as claimed in claim 1, wherein the plate member includes an electrically connecting end disposed on two sides of the recess so as to contact with the conduction member of the base to transmit the power source to the LED unit.

4. The LED light structure as claimed in claim 1, wherein the pressing projection is mounted on a top end of the retaining piece and extends outward.

5. The LED light structure as claimed in claim 1, wherein the base is formed in a square shape.
